(19) United States
(12) Patent Application Publication
(10) Pub. No.: US 2007/0274644 A1
(43) Pub. Date: Nov. 29, 2007

(54) Optical communication with wavelength separation

(76) Inventor: Arnd Kilian, Berlin (DE)

Correspondence Address: FISH & RICHARDSON P.C., P.O. BOX 1022, MINNEAPOLIS, MN, 55440-1022, US

(21) Appl. No.: 11/410,475

(22) Filed: Apr. 24, 2006

(51) Int. Cl. G02B 6/36

(52) U.S. Cl. 385/92

(57) ABSTRACT

A hermetically sealed package having a wavelength separating element is disclosed. The wavelength separating element can be adapted to reflect or transmit a wavelength or band of wavelengths selectively so that multiple distinct wavelengths in both transmitting and receiving directions can be separately processed.

### FIELD OF THE INVENTION

This invention relates to optical communication with wavelength separation.

### BACKGROUND

Commercialized optical networks employ a single optical fiber for simultaneous transmission and reception of optical signals. These networks require means for separating incoming signals from outgoing signals both optically and electrically. Conventional techniques for achieving optical separation includes using different wavelengths for different optical signals each of which is optically separated by using a wavelength sensitive filter.

However, optical assemblies employing these conventional techniques for reception and transmission of optical signals and conversion of optical signals into electrical signals must provide means for mechanical fixation and precise alignment of the additional components associated with optical separation relative to other optical elements residing in the assemblies.

Thus, conventional assemblies may not provide an integrated solution for maintaining a size that meets today's miniaturization, and reducing the overall cost of manufacturing an optical assembly.

### SUMMARY

The subject matter described herein can, in some implementations, help improve conventional optical assemblies. A relatively small optical package that is compatible in other commercialized modules used for transmission or reception of optical signals is disclosed. The optical package includes an optical element. The optical element emits a light beam that exits a lens as a collimated light beam with a low divergence angle. The collimated light beam is reflected by a slanted sidewall of a wavelength separating element with a thin film filter coated thereon, and passes through a lid of the optical package. The wavelength separating element transmits a light beam at a predetermined wavelength or band of wavelengths selectively, while reflecting the light beam at the remaining wavelength(s).

In some implementations, an optical package includes an optical element to emit a light beam at a first wavelength; a light detector to detect a light beam at a second wavelength different from the first wavelength; and a wavelength separating element to selectively reflect one of the first or second wavelengths and to selectively allow the other one of the first and second wavelengths to pass through.

In some implementations, an optical package includes a base; a lid attached to the base, wherein the base and lid define a hermetically sealed interior region that encloses: an optical element to emit a light beam at a first wavelength; and a light detector to detect a light beam at a second wavelength different from the first wavelength; and a wavelength separating element to selectively reflect one of the first or second wavelengths and to selectively allow the other one of the first and second wavelengths to pass through.

In some implementations, an optical package includes a base; a lid attached to the base, wherein the base and lid define a first hermetically sealed interior region and a second hermetically sealed interior region, wherein: the first hermetically sealed interior region encloses an optical element to emit a light beam at a first wavelength; and the second hermetically sealed interior region encloses: a light detector to detect a light beam at a second wavelength different from the first wavelength; and a wavelength separating element to selectively reflect one of the first or second wavelengths and to selectively allow the other one of the first and second wavelengths to pass through.

In some implementations, an optical package includes a base; a lid attached to the base, wherein the base and lid define a hermetically sealed interior region that encloses: a first light detector to detect a light beam at a first wavelength different from the first wavelength; a second light detector to detect a light beam at a second wavelength different from the first or second wavelength; and an optical element to emit a light beam at a third wavelength; and a wavelength separating element to selectively reflect one of the first, second or third wavelengths and to selectively allow the other two of the first, second and third wavelengths to pass through.

In some implementations, an optical package mounted on a rotatable element, the optical package including a base; a lid attached to the base, wherein the base and lid define a hermetically sealed interior region that encloses: an optical element to emit a light beam at a first wavelength; a light detector to detect a light beam at a second wavelength different from the first wavelength; and a wavelength separating element to selectively reflect one of the first or second wavelengths and to selectively allow the other one of the first and second wavelengths to pass through.

Implementations of the invention may include one or more of the following advantageous features.

Optoelectronic components commonly used in optical communication systems are typically required to perform under varying environmental conditions and within tight specifications and geometric tolerances. However, as natural effects, such as moisture, accumulate, these components can become vulnerable to potential physical damage that may render the system inoperable. Accordingly, the present invention allows hermetic enclosure of these components for protection against environment-related effects.

While outgoing optical signals emitted by a light-emitting element can be proportionally amplified in the context of power, incoming optical signals, after having been transmitted and received over an optical fiber and converted into electrical signals, are typically too weak for detection. Accordingly, a pre-amplifier is provided for amplifying the electrical signals for subsequent processing.

In some implementations, the pre-amplifier can undesirably amplify electrical crosstalk induced from, for example, electrical lines connected to the light-emitting element and the light-receiving element. Accordingly, a layer of shielding material for shielding crosstalk between receiving and transmitting electrical signals is provided.

By using micro-machining, an optical package can be provided that greatly simplifies beam alignment and mechanical fixation of optical and electrical components during assembly sequence.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows an optical package in accordance with a first implementation of the present invention.

FIG. 2A shows a wavelength separating element mounted across a surrounding planar surface of a base.

FIG. 2B shows a shielding layer supplied between a wavelength separating element and a cavity.

FIG. 3 shows hermetically sealed feed-through connections used to couple metallization contacts inside an optical package to electrical contacts provided on the backside of the optical package.

FIG. 4 shows a lid of an optical package.

FIG. 5 shows an assembly and a spherical holder containing an optical package in accordance with the present invention.

FIG. 6 shows an optical package in accordance with a second implementation of the present invention.

FIG. 7 shows an optical package in accordance with a third implementation of the present invention.

FIGS. 8(a)-(f) shows a thin film filter at different stages of a manufacturing process.

FIGS. 9(a)-(g) shows a thin film filter at different stages of another manufacturing process.

Like reference symbols in the various drawings indicate like elements.

### DETAILED DESCRIPTION

In the following description, various implementations of the invention are described. However, it will be apparent to those skilled in the art that the implementations may be practiced with only some or all aspects of the disclosed features. For purposes of explanation, specific numbers, materials and configurations are set forth in order to provide a thorough understanding of the implementations. However, it will also be apparent to one skilled in the art that the implementations may be practiced without the specific details.

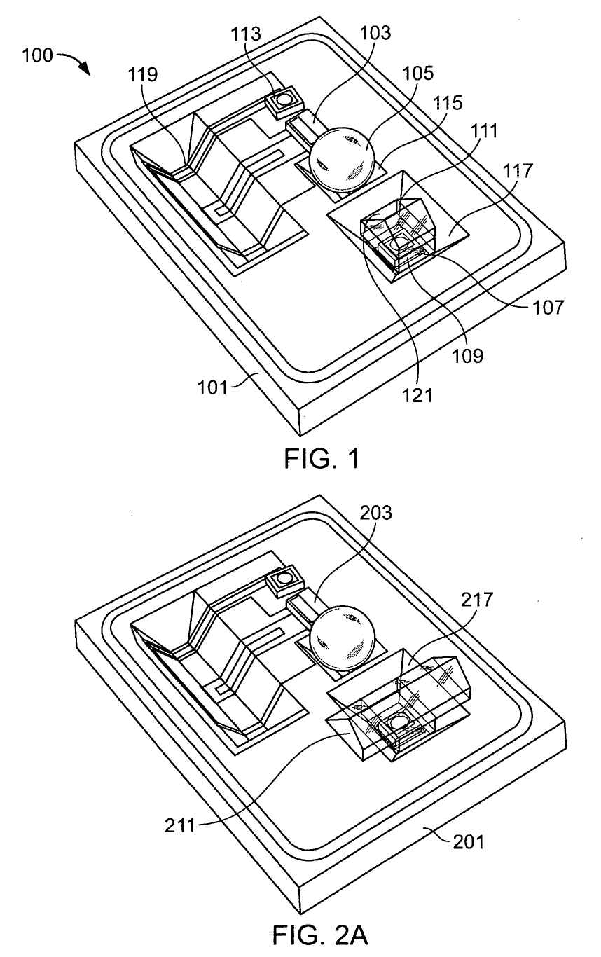

FIG. 1 illustrates an exemplary optical package 100. As shown in FIG. 1, the package 100 includes a base 101. The base 101 can be a semiconductor serving as a support on which various optoelectronic components can be mounted or in which the optoelectronic components can be formed. The base 101 can be fabricated using silicon or another suitable material.

One or more optoelectronic devices, including an optical element 103 that emits a light beam, can be mounted on the base 101. The optical element 103 can be a light-emitting element, a light-receiving element or a light transceiving element. Examples of a light-emitting element can include an edge emitting laser.

In addition to the optical element 103, the package 100 generally includes a monitor diode 113 arranged at a rear facet of the optical element 103 to monitor light beam emitted through the backside of the optical element 103, a lens 105 disposed at the front facet of the optical element 103 to collimate and refocus the light beam exiting the optical element 103, a wavelength separating element 121 to transmit a particular wavelength or band of wavelengths selectively, and a light detector 109 mounted into a recess 107 of the base 101 to detect received optical signals transmitted by external devices. Optionally, a transimpedance amplifier 107 can be provided to amplify detected signals from the light detector 109 for subsequent signal processing.

In this implementation, a ball lens is employed as the lens 105. In other implementations, a plano-convex lens, possibly made from silicon, a cylindrical graded index (GRIN) lens, or a diffractive optical element also can be used. Other suitable lenses also can be utilized if their properties allow the lens to be placed near the optical element 103 and efficiently convert the emitted light beam into a substantially collimated light beam. In some implementations, to prevent the emitted light beam from reflecting back into the optical element 103, an anti-reflective material can be coated on the surface of the lens 105.

The light detector 109 in this implementation can be, for example, a conventional photodiode. Alternatively, a positive-intrinsic-negative (PIN) photodiode or avalanche photodiode (APD) can be used.

It should be understood that optoelectronic components housed inside the package 100 are not limited to those disclosed above. Other intermediate or additional optical, electronic and optoelectronic components, including, but not limited to, lenses, optical isolators, integrated circuits, capacitors, inductors and resistors, which can be packaged together or separately from the package 100, also can be assembled in the light path.

In some implementations, the base 101 optionally includes a v-shaped groove 115 extending to the interior of the base 101 for accommodating the lens 105. The groove 115 can be etched into the base 101 using, for example, standard wet or dry etching methods, to provide mechanical support for the lens 105, thereby allowing the lens 105 to be aligned accurately and positioned opposite the optical element 103. As a result, the light beam exiting the optical element 103 can be collimated with a low divergence angle or focused by a structurally stable lens.

Depending on the size of the lens 105 and the groove 115, the lens 105 can be attached to the groove 115, for example, by bonding the lens 105 onto an adhesive pad or other attaching means previously deposited at the bottom or on a sidewall of the groove 115. Alternatively, if a groove is not provided, the lens 105 can be mounted on the surface of the base 101 to facilitate alignment to the optical element 103.

In one implementation, a cavity 117 can be etched in the interior of the base 101 to accommodate the transimpedance amplifier 107 and the light detector 109. The light detector 109 can be positioned at the bottom of the cavity 117, followed by placing the transimpedance amplifier 107 in the vicinity of the light detector 109.

As further illustrated in FIG. 1, a wavelength separating element 121 can be mounted on the light detector 109. The collimated light beam can interact with the wavelength separating element 121, which can serve to mix polarization states of a light beam incident thereon.

In one implementation, the wavelength separating element 121 can include a slanted sidewall, which lies directly across from the lens 105. The slanted sidewall can be formed, for example, by using standard etching, molding or polishing methods. The sidewall can be slanted at an angle of substantially forty five degrees. However, it should be understood that the slanted sidewall is not restricted to this angle, and can be altered to fit a particular design to achieve maximum optical coupling.

The wavelength separating element 121 can include a thin-film filter 111 bonded or adhered thereto and serving to pass a light beam at a particular wavelength or band of wavelengths, while reflecting or absorbing the light beam at other wavelength(s) emitted by the optical element 103. The thin film filter 111 can be laminated or bonded to the slanted sidewall of the wavelength separating element 121 using an adhesive or solder.

In some implementations, the particular wavelength or band of wavelengths that passes through the thin film filter 111 can depend on the angle of the slanted sidewall of the wavelength separating element 121. If a grating is employed as the wavelength separating element 121, only light beams at the selected wavelength or band of wavelengths can be diffracted.

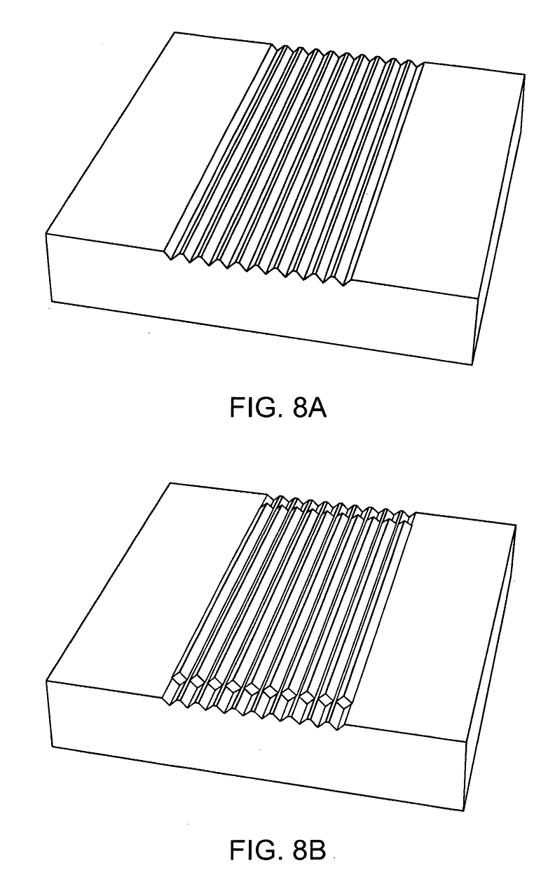

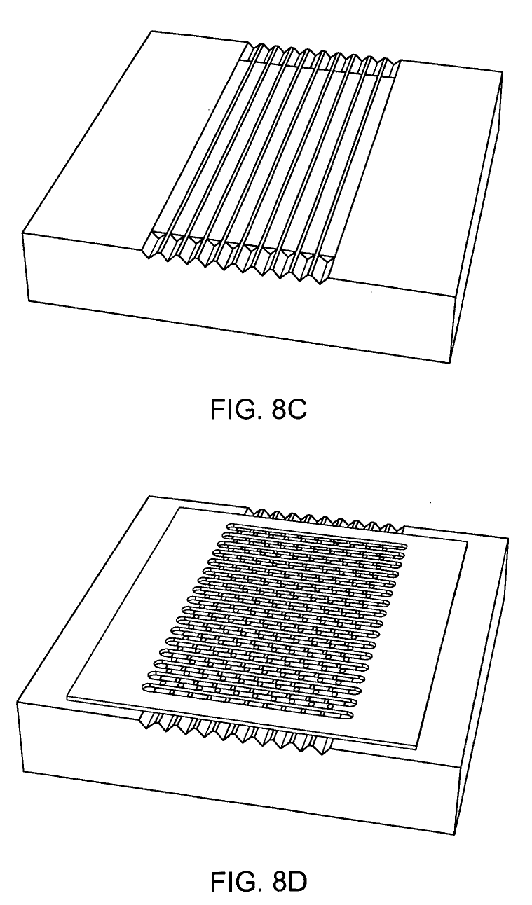

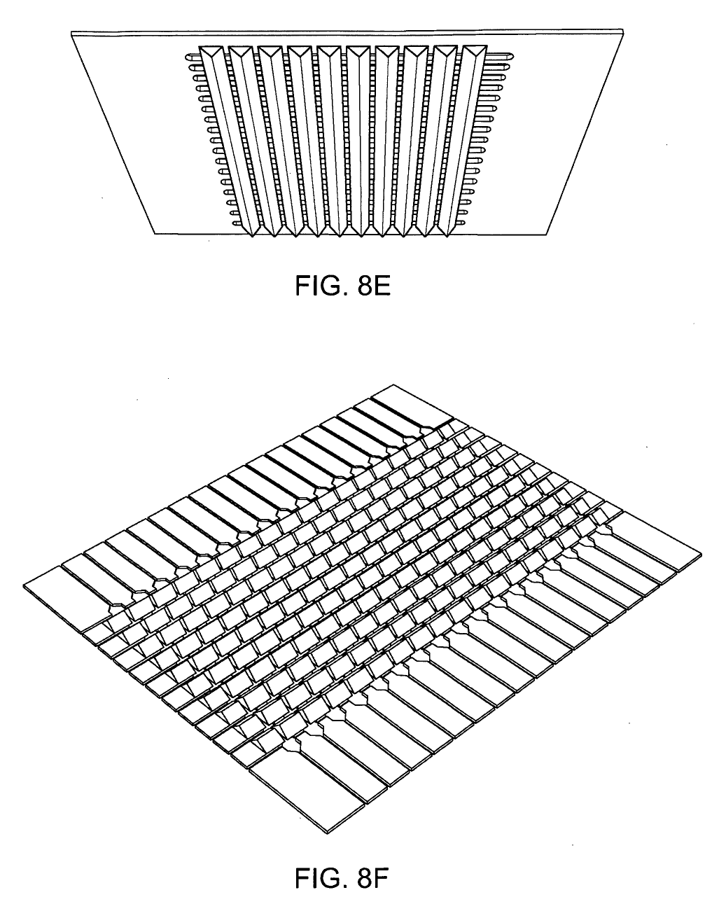

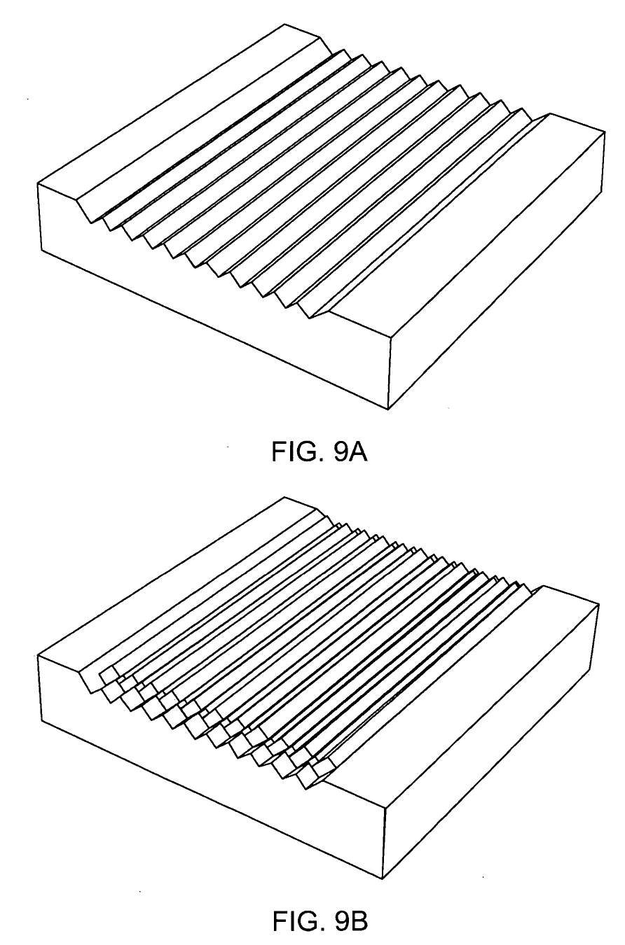

FIGS. 8(a)-(f) shows a thin film filter coated on a slanted sidewall at different stages of a manufacturing process. Initially, a thin film filter coating is formed on a continuous substrate by depositing alternating layers of high and low index material that can include a transparent dielectric.

In some implementations, adjusting the number of alternating layers also adjust the index, thickness and reflection/transmission properties of the thin film filter coating. If desired, the thin film filter coating can be configured to transmit a selected wavelength or band of wavelengths (e.g., 1550 nm) at a particular incident angle and/or polarization while independently reflecting light beam at another wavelength or band of wavelengths (e.g., 1310 nm).

Subsequently, the substrate having the thin film filter coating coated thereon is cut into stripes. Referring to FIG. 8(a), an assembly tool can be structurally provided by machining a metal piece (e.g., 25×25 mm) into a block having predetermined slots each of which includes one or more appropriately angled sidewalls. The stripes with the thin film filter coating can then be bonded temporarily into the slots with the coating held facing downwards at a well controlled angle by the sidewall of the respective slot. The glass stripes can be designed to withstand cooling liquid required during a grinding stage so as to prevent any potential damage to the glass wafer during the subsequent removal stage, as will be described below.

Next, as shown in FIG. 8(c), the surface of the glass wafer can be grinded (or polished) to form triangular shaped bars. In FIG. 8(d), a glass plate can be adhesively bonded to the surface of the glass wafer that can intersect with the beam path, and can have a refractive index close to that of the glass wafer. The glass plate can have elongated grooves formed by, for example, sandblasting, to facilitate mounting filtering unit(s) on top surface of the glass wafer.

In some implementations, the glass plate can be coated with an additional thin film filter coating designed to block a particular wavelength spectrum so as to improve optical isolation. Alternatively, the glass plate can be coated with a metal coating having circular windows thereof to reduce electromagnetic interference induced by components housed inside the package, as will be described in greater detail later.

As shown in FIGS. 8(e) and 8(f), after removing the glass plate with the triangular shaped bars adhered thereto from the assembly tool, the glass plate is diced to form multiple thin film filter assemblies each of which can be picked and placed to form a wavelength separating element.

Referring back to FIG. 1, during operation, the optical element 103 emits a light beam that exits the lens 105 as a collimated light beam with a low divergence angle. The optical element 103 can be selected based on its output wavelength and the transmission band of the thin film filter 111. The transmission band can include, but is not limited to, wavelengths of 1310 nm and 1550 nm. Then, the collimated light beam is reflected by the slanted sidewall of the wavelength separating element 121 with the thin film filter 111 coated thereon, and passes through the lid of the package 100. Particularly, the wavelength separating element 121 transmits a light beam at a predetermined wavelength or band of wavelengths selectively, while reflecting the light beam at the remaining wavelength(s).

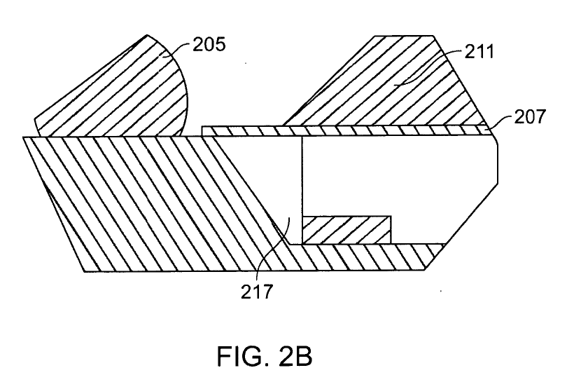

Referring to FIG. 2A, in some implementations, depending on the thickness, height and width of the wavelength separating element 211, the wavelength separating element 211 can be mounted across the surrounding planar surface of the base 201 surrounding the cavity 217, and not necessarily be placed within the cavity 217.

As a result of light transmission and reception inside the package, electromagnetic interference, a by-product of electrical and magnetic radiation, can cause signal degradation and distortion to a transmitted or received light beam. Accordingly, in some implementations, at least one sidewall of the cavity 217 includes conductive adhesives such as metal or other suitable materials to shield against electromagnetic interference propagating inside the package, and to reduce signal crosstalk between transmitting and receiving signals.

Alternatively, as shown in FIG. 2B, a shielding layer 207 can be supplied between the wavelength separating element 211 and the cavity 217 to isolate electromagnetic interference between transmitting and receiving components so that the overall characteristics of the package are not adversely affected.

In another implementation, the slanted sidewall can be coated with a reflective material, such as silicon, glass, dielectric layer stack(s) or other metal layers, so that a collimated light beam exiting the lens 205 can be redirected toward an optical waveguide outside the package at an angle of substantially ninety degrees or substantially perpendicular to the exit angle of the collimated light beam. If the emitted light beam incident upon the slant sidewall does not reflect at substantially ninety degrees, the lens 205 can accommodate such an angle.

Optionally, the wavelength separating element 211 can be mounted at a slight angle with respect to the surface of the base 201 so that light beams at wavelengths other than the selected wavelength(s) diffracted by the wavelength separating element 211 are not coupled back to the optical element. The passing wavelength(s) can depend on the precise angle at which the wavelength separating element 211 is mounted to the surface of the base 201. Alternatively, the wavelength separating element 211 can be transparent only to light beams of a particular wavelength to facilitate light transmission. By selecting a wavelength separating element having a desired transmission band, a wide range of wavelengths can be obtained.

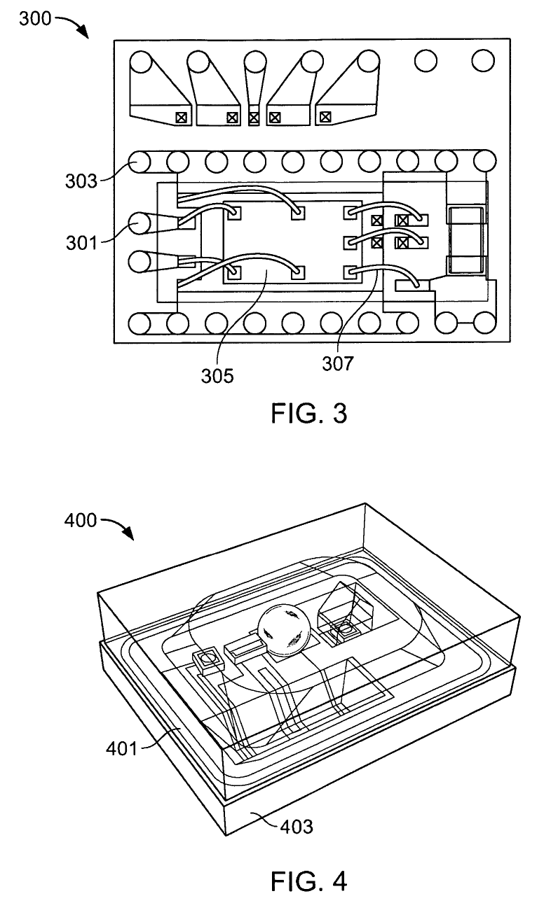

FIG. 3 shows an exemplary backside of an optical package 300. Referring to FIG. 3, the optical package 300 includes a transimpedance amplifier 305 mounted on the backside of the base 101. Alternatively, the transimpedance amplifier 305 can be mounted on the frontside of the base 101, for example, by placing the transimpedance amplifier 305 next to the light detector 109 positioned in the cavity 107. Also shown in FIG. 3 are bond wires 307 connecting the transimpedance amplifier 305 to electrical contact pads 301 on the backside of the base 101, some of which are feed-through connections used to couple metallization contacts inside the optical package 300 to electrical contacts 301 provided on the backside of the optical package 300.

Specifically, electrical contacts 301 can be routed into the package 300 through holes 303. This can be achieved by etching holes and connecting both the frontside and the backside with a suitable metallization procedure. It is possible to fabricate a hermetically sealed package by providing one fine hole for each electrical connection and using the metallization procedure appropriately to seal the hole. Bond wires or other electrical means also can be provided to connect various optoelectronic components (e.g., optical element and monitor diode) to metallization contacts 119 disposed on the surface of the base.

Various techniques can be used to form the hermetically sealed through-hole connections. One such technique uses a multilayer structure that includes a substantially etch-resistant layer sandwiched between a first semiconductor layer and a second semiconductor layer. The first and second semiconductor layers can include a material selected, for example, from a group comprising silicon nitride, silicon oxy-nitride or silicon dioxide. The through-holes can be formed using a double-sided etching process in which the first and second semiconductor layers are continuously etched until the etch-resistant layer is exposed to define the locations of the through-holes. The through-holes then can be formed by removing part of the etch-resistant layer.

The through-holes can be hermetically sealed, for example, using an electro-plated feed-through metallization process as the base for the through-hole connections. The feed-through metallization also can include a diffusion barrier, and the sealing material can include, but is not limited to, a non-noble metal.

Further details of such feed-through metallization techniques are disclosed in related U.S. Pat. No. 6,818,464 assigned to the assignee of the instant application, the disclosure of which is incorporated herein by reference in its entirety.

To form a hermetically sealed package, as shown in FIG. 4, the base 403 can be soldered to a lid 401 to encapsulate the optoelectronic components therein. The lid 401 can be fabricated using materials such as, but not limited to, silicon, glass or other suitable materials. The lid 401 and the base 403 can be soldered or fused together to achieve a hermetically sealed package that encapsulates the optoelectronic components mounted on the base 403.

In some implementations, the lid 401 can include an interior region for accommodating the optoelectronic components. The interior region can be sufficiently deep so that optoelectronic components positioned inside the package 400 are not in contact with the sidewalls of the interior region.

In another implementations, the lid 401 can include feed-through metallization to permit electrical connections from external device(s) to connect to the optoelectronic components housed inside the package 400. Yet in another implementations, the lid 401 can also serve as a transparent window for the emitted light beam. Particularly, the lid 401 can be designed to serve as a partial reflector that allows light beams at a selected wavelength(s) to pass and light beams at other wavelength(s) to be reflected or absorbed.

As discussed previously, the light beam emitted by the optical element can be reflected toward an optical waveguide exterior to the package. In some implementations, the performance of the package can depend on how well its output light beam can be coupled into the optical waveguide, and how well its input light beam from the optical waveguide is coupled to the light detector. This coupling efficiency is typically intolerant to slight changes in the alignment geometry.

Accordingly, in some implementations, one or more tightly controlled assembly steps can be utilized and the sum of all previously incurred alignment can be adjusted or compensated in a single active alignment process. In these implementations, to ensure maximum light coupling efficiency between the output of the optical element 103 and the optical waveguide and between the optical waveguide and the light detector 109, prior to affixing the lid onto the base 101, the optical element 103, the lens 105, the wavelength separating element 121 and the light detector 109 can be mounted onto the base 101 in an exact geometrical constellation relative to each other. This can be aided by precision mechanical alignment structures, e.g. a groove for the lens.

In some implementations, slight deviation from the exact constellation can be tolerated if a single active alignment process is performed once every component has been positioned. For example, while one or more optical components residing in the package can be positioned relative to each other within an accuracy of 4 μm for maximum coupling purposes, which can be achieved by using state of the art high precision assembly machines, many of the remaining components can be placed within an accuracy of 20 μm, which can easily be achieved using standard state of the art assembly machines. With these relaxed requirements for the precision of the package, an active alignment process is performed. The active alignment process can include measuring the optical output at the far end of the optical waveguide, and relatively adjusting the position of the respective component(s) until a point at which maximum optical coupling is reached. Further details of such techniques are disclosed in related U.S. patent application Ser. No. 11/225,758, the disclosure of which is incorporated herein by reference in its entirety.

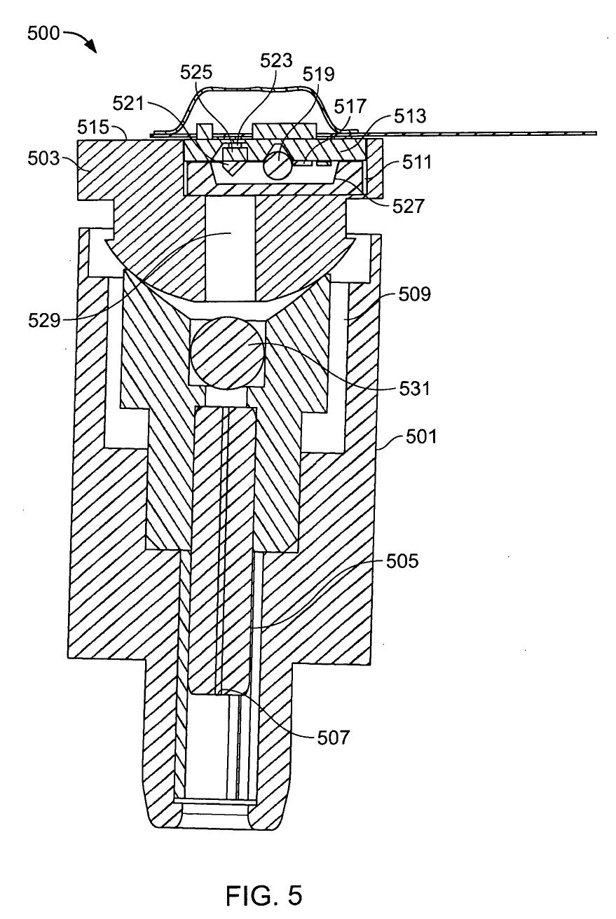

FIG. 5 illustrates an assembly and a spherical holder incorporating a package in accordance with the present invention.

As shown in FIG. 5, the package 513 can be assembled and placed into a hollow region 511 of a rigid spherical holder 503. The package 513 also can be placed on the exterior surface 515 of the spherical holder 503.

As a result of difficult alignment of the collimating optics and geometric intolerance associated with the components inside the package, light beams exiting the package can be offset with respect to the axis of the optical waveguide. To reduce the complexity, time consumption and cost associated with such alignment, after the package 513 is secured to the spherical holder 503, the spherical holder 503 containing the package 513 can be incorporated into the assembly 500 to facilitate proper beam alignment with respect to the optical waveguide 507. The assembly 500 generally includes a housing 501, which includes an opening 509 for receiving the spherical holder 503. The housing 501 can be constructed using conventional milling and drilling processes, and can be made from metal or other suitable materials. Inside the housing 501, a connector-receptacle can be provided with a ferrule sleeve 505 to accommodate the optical waveguide 507.

For illustrative purposes, an optical fiber is shown as the optical waveguide 507. The optical fiber generally includes a core and a cladding which concentric-circularly surrounds the core, so that a light beam is input at one end, reflected by the boundary between the core and the cladding, and transmitted to devices at the other end. The periphery of the cladding is commonly protected by a jacket.

Once the spherical holder 503 is properly assembled and aligned with the housing 501, any beam misalignment incurred due to geometrical intolerances can be compensated by simply rotating the spherical holder 503 across the opening 509 until a maximum or other desired coupling is reached.

In some implementations, the lens 531, which includes, but is not limited to, a ball lens or graded index lens, can be positioned between the optical waveguide 507 and the spherical holder 503 to further collimate the light beam exiting the package 513. Likewise, the lens 531 can function to collimate a light beam exiting the optical waveguide 507 for coupling into the package 513.

A transmission process for transmitting a light beam from a package is described below.

During transmission, the optical element 517 emits a light beam, which exits the lens 519 as a collimated light beam with a low divergence angle. The collimated light beam is then reflected by the slanted sidewall of the wavelength separating element 521 and passes through the lid 527 of the package 513 as an outgoing beam. Particularly, the wavelength separating element 521 selectively passes a light beam at a desired wavelength or band of wavelengths, and reflects or absorbs the light beam at other wavelength(s). The exiting light beam, which is transparent to the lid 527, then is fed through the channel 529 and into the lens 531. After the light beam is collimated by the lens 531, the light beam is transmitted and coupled to the optical waveguide 507.

To receive a light beam emitted through the optical waveguide 507, the light beam can be collimated by the lens 531, and fed through the channel 529 and the lid 527. The received light beam is incident upon the slanted sidewall of the wavelength separating element 521. By reflecting or absorbing the unwanted wavelength(s), only the desired wavelength or band of wavelengths passes through the wavelength separating element 521 so that it can be detected and amplified by the light detector 525 and the transimpedance amplifier 523 for subsequent signal processing.

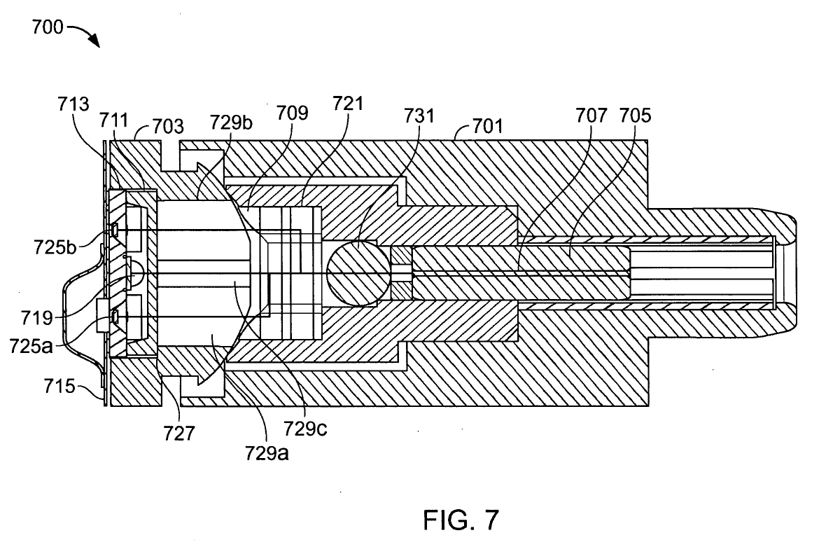

In some implementations, as will be discussed in greater details with respect to FIG. 7, the bi-directional scheme described above can provide the package 513 an ability to process more than one distinct wavelength in both transmitting and receiving directions, thereby increasing the bandwidth capacity that can be delivered using a single optical package and reducing the number of components necessary for separately transmitting and receiving signals.

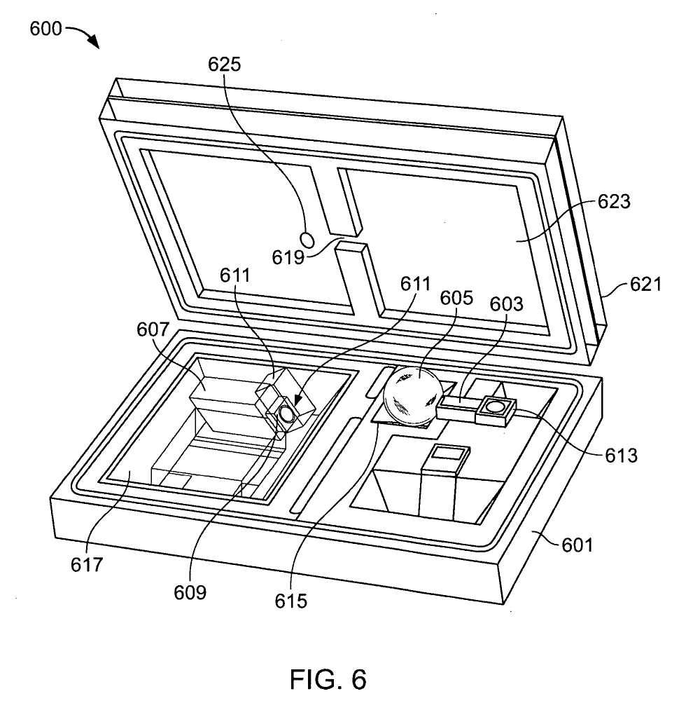

FIG. 6 illustrates an optical package in accordance with a second implementation of the present invention.

Referring to FIG. 6, the package 600 generally includes a base 601, an optical element 603 mounted on the base 601 to emit a light beam, a monitor diode 613 arranged at a rear facet of the optical element 603 to monitor light beam emitted through the backside of the optical element 603, a lens 605 disposed at the front facet of the optical element 603 to collimate the light beam exiting the optical element 603, a wavelength separating element 611 to transmit a selected wavelength or band of wavelengths, and a light detector 609 to detect received optical signals transmitted by external devices. If desired, a transimpedance amplifier can be incorporated to amplify signals detected by the light detector 609 for subsequent signal processing.

Similar to the package 100 shown in FIG. 1, the package 600 also can include a v-shaped groove 615 and a cavity 617 extending to the interior of the base 601 to accommodate the lens 605, and the light detector 609, respectively. To form a hermetically sealed package, the base 601 can be soldered to a lid 621 to encapsulate the optoelectronic components therein. The lid 621 can be fabricated from materials such as, but not limited to, silicon, glass or other suitable materials. The lid 621 and the base 601 can be soldered or fused together to achieve a hermetically sealed package that encapsulates the optoelectronic components mounted on the base 601.

As discussed with respect to FIG. 1, electromagnetic interference propagating inside the package 600 can lead to signal degradation. Accordingly, in some implementations, part of the interior regions 623 of the lid 621 accommodating the optoelectronic components can be coated with conductive material such as metal to isolate transmitting components from the receiving components. In these implementations, the lid 621 is provided with a channel 619 for light beams exiting the lens 605 to pass to the wavelength separating element 611. The size of the channel 619 can be designed to permit a collimated light beam to pass without being blocked or partially blocked. The lid 621 also can be provided with a window 625 from which the selected wavelength or band of wavelengths can be emitted to external devices, or through which light beam emitted from external devices is received and diffracted by the wavelength separating element 611. Window 625 can be a hollow region to facilitate transmission or reception of a light beam. Alternatively, window 625 can include one or more films that are transparent to the transmitted or received light beam.

While the light detector 109 shown in FIG. 1 can be mounted at the bottom of the cavity, the light detector 609 in this implementation can be in direct contact with the bottom surface of the wavelength separating element 611, both of which can be mounted at a tilted angle with respect to the surface of the base 601 for receiving or transmitting a light beam. In some implementations, this can be achieved by mounting the light detector 609 and the wavelength separating element 611 onto the top surface of a trapezoidal shaped submount 607, tilting and fastening these components at an angle of 45° and onto the bottom of the cavity 617.

The submount 607 can be formed by using standard etching, molding or polishing methods to accommodate the slanted position at which the light detector 609 and wavelength separating element 611 are mounted and then metallized appropriately to form electrical lines serving as conductive means for conducting signal(s) between the light detector 609 and surrounding electrical pads.

In some implementations, a transimpedance amplifier can be placed in direct vicinity of the light detector 609, and bond wires can be employed to connect the transimpedance amplifier to electrical pads associated with the submount 607.

FIG. 7 illustrates an optical package in accordance with a third implementation of the present invention.

As shown in FIG. 7, the package 713 can be assembled and placed into a hollow region 711 of a rigid spherical holder 703. Alternatively, the package 713 can be placed on the exterior surface 715 of the spherical holder 703.

After the package 713 is secured to the spherical holder 703, the spherical holder 703 containing the package 713 can be mounted onto the assembly 700 to facilitate proper beam alignment with respect to the optical waveguide 707. Similar to that discussed in FIG. 5, the assembly 700 generally includes a housing 701, which includes an opening 709 for receiving the spherical holder 703. Inside the housing 701, a connector-receptacle can be provided with a ferrule sleeve 705, to accommodate the optical waveguide 707.

In this implementation, the wavelength separating element 721 is positioned outside the package 713 (e.g., inside assembly 700). During transmission, a light beam collimated by the lens 719 having a low divergence angle is fed through the lid 727 and the channel 729c. The collimated light beam is then reflected or diffracted by the wavelength separating element 721 so that a selected wavelength or band of wavelengths collimated by the lens 731 is optically coupled to the optical waveguide 707.

Unlike the wavelength separating element previously discussed with respect to FIG. 1, the wavelength separating element 721 in this implementation utilizes both top and bottom surfaces, and a variation in the angle at which the wavelength separating element 721 is mounted can merely result in an minimal offset that can be tolerated because of the size of the receiving area of light detectors 725a and 725b.

In some implementations, the wavelength separating element 721 can include a thin-film filter bonded or adhered thereto serving to pass a light beam at a particular wavelength or band of wavelengths, while reflecting or absorbing the light beam at other wavelength(s) emitted by the optical element 103. The thin film filter can be laminated or bonded to at least one of the top and bottom surfaces of the wavelength separating element 721 using an adhesive or solder.

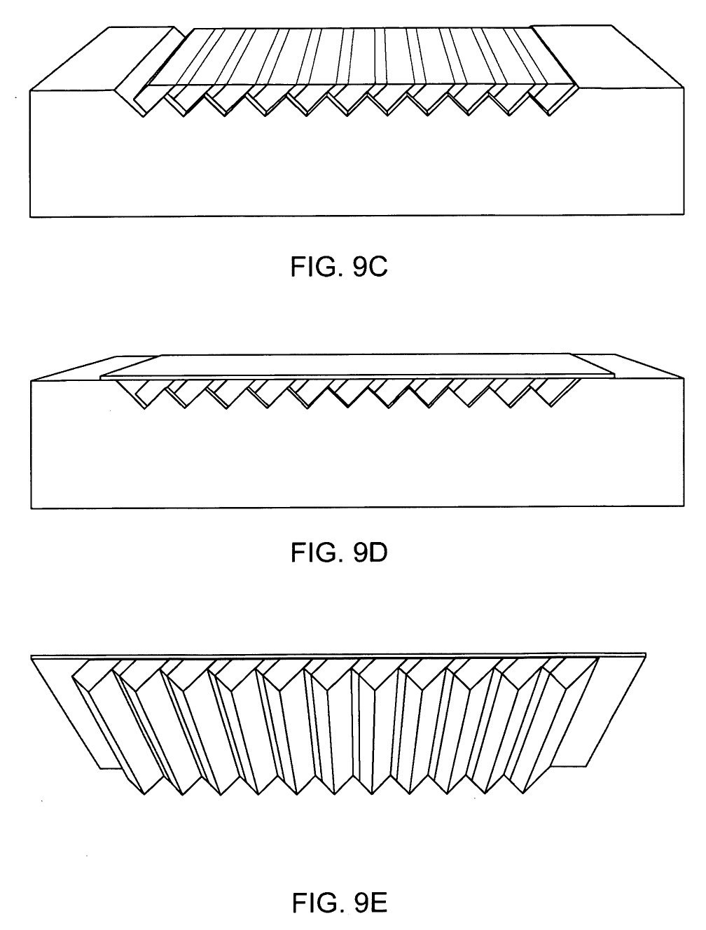

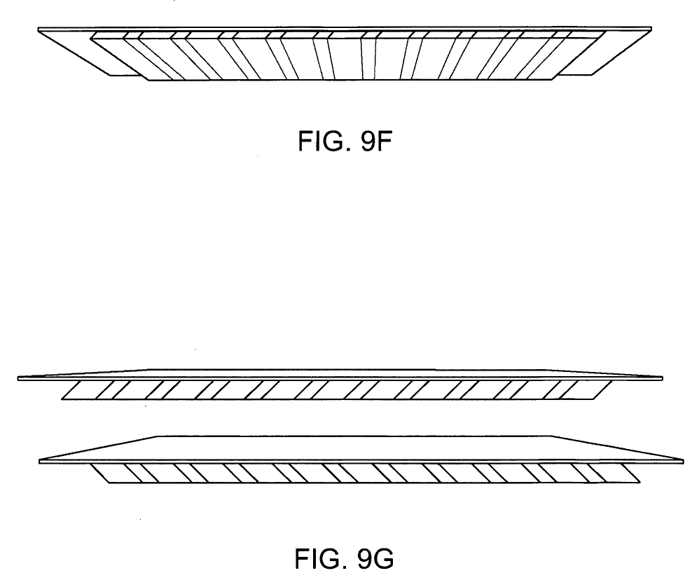

A process for manufacturing a thin film filter for use with the wavelength separating element employed in this particular implementation is described hereinbelow in conjunction with FIGS. 9(a)-9(f).

Referring to FIG. 9(a), a thin film filter can be manufactured by machining a metal block to form an assembly tool (e.g., 50×50 mm block). Then, stripes of two distinct glass wafers having different sizes can be temporarily assembled onto the assembly tool, as shown in FIG. 9(b).

In some implementations, one glass wafer can be thinner than the other glass wafer, and can have one surface coated with a filter coating and the other surface coated with a totally-reflective material. Both glass wafers can be embedded to the surface of the assembly tool using optical adhesive or other suitable means.

In other implementations, each glass wafer can have only one side coated with a filter coating, and the other side uncoated. The coated side can transmit a light beam at a selected wavelength or band of wavelengths (e.g., 1310 nm) at a particular incident angle (e.g., forty five degrees) and/or polarization, while independently reflecting or absorbing the light beam at another wavelength or band of wavelengths (e.g., 1550 nm).

Next, as shown in FIG. 9(c), the non-contacting surface (i.e., top surfaces) of the glass stripes can be grinded using conventional grinding techniques. In FIG. 9(d), a glass plate having, for example, anti-reflective coating coated thereon, can be adhesively bonded to the surface of the glass wafers.

As shown in FIG. 9(e), the glass plate and the glass wafers can be removed by, for example, using and dissolving aluminum and diluted hydrochloric acid into the assembly tool. After grinding, a thin film filter assembly is complete as shown in FIG. 9(f), and can be bonded to one or both surfaces of a wavelength separating element.

While only a single thin film assembly has been illustrated, multiple thin film assemblies also can be assembled onto a wavelength separating element each of which serves to separate a particular wavelength or band of wavelengths. For example, as shown in FIG. 9(g), multiple glass stripes can be used in a second thin film assembly. The first thin film assembly, if desired, can function to separate a first wavelength and a second wavelength from a third wavelength and fourth wavelength, while the second thin film assembly can serve to further separate the first wavelength from the second wavelength, and the third wavelength from the fourth wavelength. Accordingly, the wavelength separating element can accommodate a wide range of wavelengths suitable for a variety of applications.

Referring back to FIG. 7, the package 713 includes two light detectors 725a and 725b each of which can be positioned inside a corresponding cavity. During reception, a light beam passing through the optical waveguide 707 and collimated by the lens 731 is incident upon the wavelength separating element 721. Through the wavelength separating element 721, the light beam at a selected wavelength or band of wavelengths can be reflected to the light detector 725a through region 729a, while the light beam at another selected wavelength or band of wavelengths can be reflected to the light detector 725b through region 729b.

In some implementations, regions 729a and 729b are transparent to only light of the selected wavelength or band of wavelengths to facilitate light reception. The received light beam can be detected and converted into electrical signals by the light detectors, followed by amplification through transimpedance amplifiers.

These advantages and improvements in multi-wavelength transmission and detection are particularly beneficial in systems where large information carrying capacity is desired. By independently transmitting and detecting light at multiple wavelengths simultaneously, the potential of the package also can be extended to various applications in addition to those discussed in this disclosure, such as systems directed to adding or dropping multiple optical channels through a single optical fiber.

In one particular implementation, only one of the light detectors 725a and 725b is coupled to a transimpedance amplifier. In another implementation, multiple light detectors for receiving a wide spectrum of wavelengths can be supplied. Multiple optical elements with different emission bands also can be provided inside the package that can be suitable for wavelength division multiplex applications.

Accordingly, the wavelength separating element provides enhanced performance including wavelength selectivity and reduced electromagnetic or crosstalk interference to a passing or received signal without adverse effects to the selection characteristic of the package, which effectively eliminates undesired signals while reflecting or blocking distortion exerted to a desired signal.

The terms “lid” and “base”, as used above are not intended to imply a particular orientation of those sections with respect to the top or bottom of the package. In some implementations, the base can be located above the lid, whereas in other implementations, the lid can be located below the base.

In general, those skilled in the art will recognize that the invention is not limited by the details described. Instead, the invention can include modifications and alterations within the spirit and scope of the appended claims. For example, while the implementations discussed above only describe components that are illustrated in the corresponding figure, the subject matter disclosed herein is not limited to those applications, and other devices such as electro-magnetic devices, chemical devices, micro-mechanical devices, micro-electromechanical system (MEMS) devices, micro-optoelectromechanical system (MOEMS) devices or other devices that contain tiny, micron and sub-micron-sized elements and chips also can be incorporated into the optical package. The description is thus to be regarded as illustrative instead of restrictive of the invention. Other implementations are within the scope of the claims.

What is claimed is:

1. An apparatus comprising:
a base;
a lid attached to the base, wherein the base and lid define a hermetically sealed interior region that encloses:
an optical element to emit a light beam at a first wavelength; and
a light detector to detect a light beam at a second wavelength different from the first wavelength; and
a wavelength separating element to selectively reflect one of the first or second wavelengths and to selectively allow the other one of the first and second wavelengths to pass through.

2. The apparatus of claim 1 wherein the wavelength separating element is adapted to selectively reflect the first wavelength toward the lid, and to allow the second wavelength selectively to pass through so that it is directed toward the light detector.

3. The apparatus of claim 1 wherein the lid is transparent to the first and second wavelengths.

4. The apparatus of claim 1 further comprising a transimpedance amplifier to process signals from the light detector.

5. The apparatus of claim 1 where the first wavelength is in a range of 1550 nm, and the second wavelength is in a range of 1310 nm.

6. The apparatus of claim 1 wherein the interior region is coated with a conductive material to reduce electromagnetic interference induced inside the apparatus.

7. The apparatus of claim 1 wherein the base includes a cavity to accommodate the light detector.

8. The apparatus of claim 1 wherein the light beam at the first wavelength is reflected toward the lid at an angle of substantially ninety degrees.

9. The apparatus of claim 1 further comprising a lens to collimate at least one of the emitted light beam or detected light beam.

10. The apparatus of claim 9, further comprising a groove extending to an interior of the base to accommodate the lens.

11. The apparatus of claim 1 wherein the lid includes a window to allow the emitted light beam or the detected light beam to pass through the lid.

12. The apparatus of claim 1 further comprising a monitor diode near a rear facet of the optical element to monitor a light beam emitted through a backside of the optical element.

13. An apparatus comprising:
a base;
a lid attached to the base, wherein the base and lid define a first hermetically sealed interior region and a second hermetically sealed interior region,
wherein:
the first hermetically sealed interior region encloses an optical element to emit a light beam at a first wavelength; and
the second hermetically sealed interior region encloses:
a light detector to detect a light beam at a second wavelength different from the first wavelength; and
a wavelength separating element to selectively reflect one of the first or second wavelengths and to selectively allow the other one of the first and second wavelengths to pass through.

14. The apparatus of claim 13 wherein the lid includes a channel to allow the emitted light beam to pass to the wavelength separating element.

15. The apparatus of claim 13 further comprising a transimpedance amplifier to process signal from the light detector.

16. An apparatus comprising:
a base;
a lid attached to the base, wherein the base and lid define a hermetically sealed interior region that encloses:
a first light detector to detect a light beam at a first wavelength different from the first wavelength;
a second light detector to detect a light beam at a second wavelength different from the first or second wavelength; and
an optical element to emit a light beam at a third wavelength; and
a wavelength separating element to selectively reflect one of the first, second or third wavelengths and to selectively allow the other two of the first, second and third wavelengths to pass through.

17. The apparatus of claim 16 wherein the wavelength separating element is adapted to selectively reflect the third wavelength toward the lid, and to allow the second and third wavelengths to pass through the lid so that the second and third wavelengths are directed respectively toward the first light detector and the second light detector.

18. The apparatus of claim 16 further comprising a transimpedance amplifier coupled to one of the first light detector or the second light detector and configured to electrically process a detected light beam.

19. An apparatus comprising:
an optical package mounted on a rotatable element, the optical package including:
a base;
a lid attached to the base, wherein the base and lid define a hermetically sealed interior region that encloses:
an optical element to emit a light beam at a first wavelength;
a light detector to detect a light beam at a second wavelength different from the first wavelength; and
a wavelength separating element to selectively reflect one of the first or second wavelengths and to selectively allow the other one of the first and second wavelengths to pass through.

20. The apparatus of claim 19 further comprising an optical waveguide connected to the optical package, wherein the optical waveguide is adapted to transmit a light beam to the light detector or to receive a light beam emitted from the optical element.

21. The apparatus of claim 20, wherein the rotatable element includes a channel to allow at least one of the emitted light beam or the detected light beam to be transported to or from the optical waveguide.

22. The apparatus of claim 20 wherein the optical waveguide is mounted on an optical assembly having an opening to receive the optical package mounted on the rotatable element, and wherein the rotatable element is flexibly rotatable around the opening.

23. The apparatus of claim 19 further comprising another light detector enclosed by the hermetically sealed interior region to detect a light beam at a third wavelength different from the first and second wavelengths.
